(19) United States
(12) Patent Application Publication
(10) Pub. No.: US 2007/0279523 A1
(43) Pub. Date: Dec. 6, 2007

(54) Frame rate conversion apparatus and frame rate converson method

(75) Inventor: Himio Yamauchi, Yokohama-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,201

(22) Filed: May 30, 2007

(30) Foreign Application Priority Data
May 31, 2006 (JP) 2006-151582

(51) Int. Cl. H04N 7/01

(52) U.S. Cl. 348/441

(57) ABSTRACT

According to one embodiment, frame rate conversion apparatus including scaling circuit which scales up or scales down an input image signal, and outputs it, first frame memory which stores image signal, supplying means for supplying an input image signal before being scaled up, motion vector detecting circuit which detects motion vector based on the input image signal before being scaled up, motion vector scaling circuit which carries out scaling onto the motion vector and outputs it, interpolation frame generating circuit which generates and outputs image signal to be interpolated on the basis of the motion vector, output signal from the scaling circuit, and image signal, and readout circuit unit which receives the image signal from the first frame memory, and the image signal to be interpolated from the second frame memory, and outputs those in accordance with frame rate.

### CROSS-REFERENCE TO RELATED APPLICATIONS

This application is based upon and claims the benefit of priority from Japanese Patent Application No. 2006-151582, filed May 31, 2006, the entire contents of which are incorporated herein by reference.

### BACKGROUND

1. Field

One embodiment of the invention relates to a frame rate conversion apparatus, and in particular, to a frame rate conversion apparatus and a frame rate conversion method corresponding to a failure in motion vector detection at the time of scaling up an input image .

2. Description of the Related Art

It has been known that, in a frame rate conversion apparatus, for example, at the time of scaling up an input image to a liquid crystal panel size and outputting it at a frame rate being raised, when motion vectors among frames are detected with respect to the scaled-up image as in a conventional way, a detection accuracy is deteriorated. Namely, in addition to the fact that a range of searching motion vectors becomes narrower than that in a case of equimultiple or a case of scaling-down, there are cases in which, when nonlinear scaling of an image at an aspect ratio of 4:3 into 16:9 is carried out, it is hard to detect motion vectors because a shape of an object is changed.

In Patent Document 1 (Jpn. Pat. Appln. KOKAI Publication No. 2000-134585), a frame rate conversion is carried out such that motion vectors are generated for each pixel on the basis of input image signals sequentially converted into operations in an IP conversion unit, and one frame previous input image signals, and interpolation frames are generated by utilizing these motion vectors.

In the conventional art in the Patent Document 1 as well, there is disclosed no countermeasure against a failure in motion vector detection at the time of scaling up image information.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of a first frame rate conversion apparatus according to one embodiment of the present invention;.

FIG. 2 is a block diagram showing one example of the first frame rate conversion apparatus according to one embodiment of the present invention;

FIG. 3 is a block diagram showing one example of the first frame rate conversion apparatus according to one embodiment of the present invention;

FIG. 4 is an explanatory diagram showing one example of timings of respective signals in the frame rate conversion apparatus according to one embodiment of the present invention; and

FIG. 5 is an explanatory diagram showing one example of a method for scaling motion vectors in the frame rate conversion apparatus according to one embodiment of the present invention.

### DETAILED DESCRIPTION

Various embodiments according to the invention will be described hereinafter with reference to the accompanying drawings. In general, according to one embodiment of the invention, a frame rate conversion apparatus comprising: a scaling circuit which scales up or scales down an input image signal, and outputs it; a first frame memory which stores an image signal from the scaling circuit; supplying means for supplying an input image signal before being scaled up when the scaling circuit has scaled up the input image signal; a motion vector detecting circuit which receives the input image signal before being scaled up from the supplying means, and which detects a motion vector on the basis of the signal; a motion vector scaling circuit which carries out scaling onto the motion vector from the motion vector detecting circuit, and outputs it; an interpolation frame generating circuit which generates and outputs an image signal to be interpolated on the basis of the motion vector from the motion vector scaling circuit, an output signal from the scaling circuit, and an image signal from the first frame memory; a second frame memory which stores the image signal to be interpolated from the interpolation frame generating circuit; and a readout circuit unit which receives the image signal from the first frame memory, and the image signal to be interpolated from the second frame memory, and outputs those in accordance with a frame rate.

One embodiment according to the present invention provides a frame rate conversion apparatus and a frame rate conversion method in which a deterioration in a motion vector detection accuracy at the time of scaling up an input image signal is prevented.

One embodiment provides a frame rate conversion apparatus comprising: a scaling circuit (11) which scales up or scales down an input image signal (S0), and outputs it; a first frame memory (13) which stores an image signal from the scaling circuit; supplying means (14, 18, 19:14, 22:31, 32) for supplying an input image signal before being scaled up when the scaling circuit has scaled up the input image signal; a motion vector detecting circuit (20) which receives the input image signal before being scaled up from the supplying means, and which detects a motion vector on the basis of the signal; a motion vector scaling circuit (21) which carries out scaling onto the motion vector from the motion vector detecting circuit, and outputs it; an interpolation frame generating circuit (15) which generates and outputs an image signal to be interpolated on the basis of the motion vector from the motion vector scaling circuit, an output signal from the scaling circuit, and an image signal from the first frame memory; a second frame memory (16) which stores the image signal to be interpolated from the interpolation frame generating circuit; and a readout circuit unit (17) which receives the image signal from the first frame memory, and the image signal to be interpolated from the second frame memory, and outputs those in accordance with a frame rate.

In accordance therewith, even when an input image signal is scaled up, it is possible to highly accurately detect motion vectors, and therefore, there are provided a frame rate conversion apparatus and a frame rate conversion method in which it is possible to generate a strain-free frame-rate-converted image.

Hereinafter, the embodiment of the present invention will be described in detail with reference to the drawings.

Note that, in the present embodiment, to cite an example of frame rate conversion, there is a case in which a frequency of an image signal is converted from 60 Hz into 120 Hz or the like. Further, in a case of carrying out scaling-up/down of an image, to cite a general example on a liquid crystal display, there is a case in which an image signal of 720×480 pixels in SD (NTSC) is scaled up about 1.8 times to 1366×768 pixels for a WXGA panel. However, the present invention is not limited to these examples.

### Frame Rate Conversion Apparatus According to One Embodiment of the Present Invention

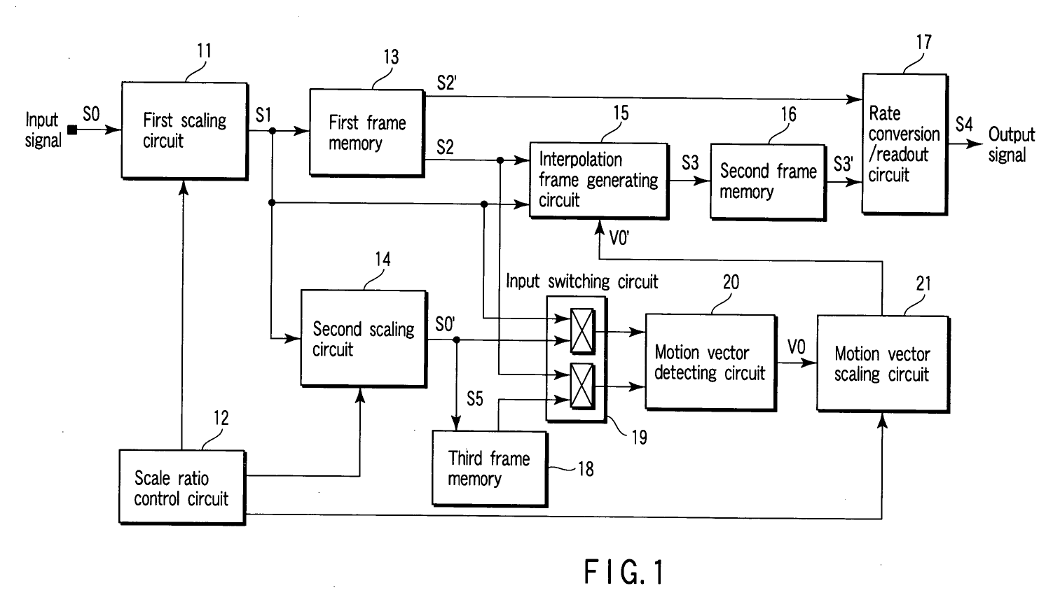

First, a first frame rate conversion apparatus according to one embodiment of the present invention will be described by using FIG. 1. FIG. 1 is a block diagram showing one example of the first frame rate conversion apparatus according to the one embodiment of the present invention.

The first embodiment is a frame rate conversion apparatus in which a deterioration in a motion vector detection accuracy is prevented by restoring an input image signal to the original input image signal before being scaled up by a second scaling circuit.

The first frame rate conversion apparatus according to the one embodiment of the present invention is a dynamic image frame rate conversion apparatus in which an input image signal is scaled up/down, and is outputted at a frame rate being converted. Namely, as shown in FIG. 1, the frame rate conversion apparatus has a first scaling circuit 11 which scales an input image signal up/down, a scale ratio control circuit 12 which controls a scale ratio of the first scaling circuit 11, a first frame memory 13 which stores outputs from the first scaling circuit 11, an interpolation frame generating circuit 15 which generates an interpolation frame on the basis of an output from the first scaling circuit 11 and an output from the first frame memory 13, a second frame memory 16 which stores outputs from the interpolation frame generating circuit 15, and a rate conversion/readout circuit 17 which switches images to be read out of the first frame memory 13 and the second frame memory 16 in accordance with an output frame rate.

Moreover, as shown in FIG. 1, the frame rate conversion apparatus has a second scaling circuit 14 which scales down an output from the first scaling circuit 11, and a third frame memory 18 which stores outputs from the second scaling circuit 14.

Here, when the first scaling circuit 11 carries out scaling-up by the scale ratio control circuit 12, the second scaling circuit 14 carries out scaling-down such that an output from the first scaling circuit 11 is restored to a size of the original input image signal, and an input switching circuit 19 with respect to a motion vector detecting circuit 20 at a subsequent stage selects an output from the second scaling circuit 14 and an output from a third frame memory 31 to input those into the motion vector detecting circuit 20. Then, the motion vector detecting circuit 20 detects motion vectors among the input frames, and outputs those to a motion vector scaling circuit 21 at a subsequent stage.

The motion vector scaling circuit 21 carries out scaling of motion vectors such that motion vectors which are outputs from the motion vector detecting circuit 20 are made to be motion vectors between the outputs from the first scaling circuit 11 and the outputs from the first frame memory 13, and inputs those motion vectors into the interpolation frame generating circuit 15.

Function of Scaling Circuit

Note that a function of the scaling circuit described above will be described hereinafter.

There is shown one example of an operation of the motion vector scaling circuit 21 in the case of scaling-up double at a horizontal scaling factor and a vertical scaling factor by the first scaling circuit 11. In FIG. 5, pixels (x, y), (x+2, y), (x, y+2), and (x+2, y+2) are pixels of an input signal S0 and an output S0′ from the second scaling circuit 14, and pixels (x+1, y), (x, y+1), (x+1, y+1), (x+2, y+1), and (x+1, y+2) are pixels which have been interpolated by the first scaling circuit 11.

By the motion vector detecting circuit 20, motion vectors [Vx (x, y), Vy (x, y)], [Vx (x+2, y), Vy (x+2, y)], [Vx (x, y+2), Vy (x, y+2)], and [Vx (x+2, y+2), Vy (x+2, y+2)]of the pixels (x, y), (x+2, y), (x, y+2), and (x+2, y+2) are determined. In the motion vector scaling circuit 21, scaling of motion vectors is carried out so as to be motion vectors among the outputs from the first scaling circuit 11 and the outputs from the first frame memory 13 as follows.
[Vx′(x,y),Vy′(x,y)]=[2*Vx(x,y),2*Vy(x,y)]
[Vx′(x+2,y),Vy′(x+2,y)]=[2*Vx(x+2,y),2*Vy(x+2,y)]
[Vx′(x,y+2),Vy′(x,y+2)]=[2*Vx(x,y+2),2*Vy(x,y+2)]
[Vx′(x+2,y+2),Vy′(x+2,y+2)]=[2*Vx(x+2,y+2),2*Vy(x+2,y+2)]
[Vx′(x+1,y),Vy′(x+1 ,y)]=[(Vx′(x,y)+Vx′(x+2,y))/2,(Vy′(x,y)+Vy′(x+2,y))/2]
[Vx′(x,y+1),Vy′(x,y+1)]=[(Vx′(x,y)+Vx′(x,y+2))/2,(Vy′(x,y)+Vy′(x,y+2))/2]
[Vx′(x+2,y+1),Vy′(x+2,y+1)]=[(Vx′(x+2,y)+Vx′(x+2,y+2))/2,(Vy′(x+2,y) +Vy′(x+2,y+2))/2]
[Vx′(x+1,y+2),Vy′(x+1,y+2)]=[(Vx′(x,y+2)+Vx′(x+2,y+2))/2,(Vy40 (x,y+2)+Vy′(x+2,y+2))/2]
[Vx′(x+1,y+1),Vy′(x+1,y+1)]=[(Vx′(x,y)+Vx′(x+2,y)+Vx′(x,y+2)+Vx′(x+2,y+2))/4,(Vy′(x,y)+Vy′(x+2,y)+(Vy′(x,y+2)+Vy′(x+2,y+2))/4]

Motion vector values are determined by such an operation.

The interpolation frame generating circuit 15 generates interpolation frames among frames on the basis of input motion vectors, and stores those in the second frame memory 16. Then, frame rate conversion is achieved by switching images to be read out of the first frame memory 13 and the second frame memory 16 in accordance with an output frame rate by the rate conversion/readout circuit 17.

Namely, in the first frame rate conversion apparatus, as described above, an input image signal before being scaled up is generated by scaling processing by the second scaling circuit. Therefore, a failure that a motion vectors detection accuracy is deteriorated because an image signal is made extremely large by scaling, is solved. Accordingly, there is no case in which a distortion based on a deterioration in a motion vector accuracy is brought about even when frame rate processing with processing of scaling up an image signal is carried out, and it is possible to carry out high quality frame rate conversion.

### Second Embodiment

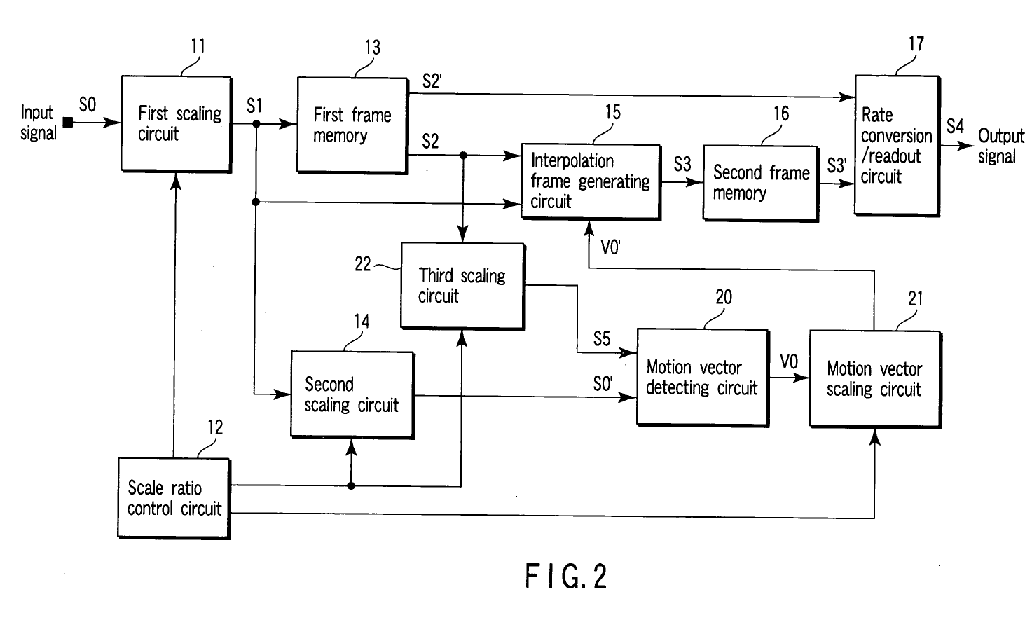

A second embodiment is to substitute that an input image signal is restored to the original input image signal before being scaled up by the second scaling circuit, and a third scaling circuit is further provided, for a delayed action of the third frame memory in the first embodiment. FIG. 2 is a block diagram showing one example of the first frame rate conversion apparatus according to one embodiment of the present invention. With respect to the frame rate conversion apparatus shown in FIG. 2, only the structure different from that in FIG. 1 will be described, and descriptions of the common structures will be omitted.

Namely, the frame rate conversion apparatus is different from that in the first embodiment in that, in order to obtain a frame delay signal of an output from the second scaling circuit 14, scaling of an output from the first frame memory 13 is carried out to be generated by the third scaling circuit in place of the third frame memory 31. Here, the third scaling circuit receives a scaling signal from the scale ratio control circuit 12, receives an output from the first frame memory 13, and supplies the image signal, onto which scaling has been carried out, to the motion vector detecting circuit 20.

### Third Embodiment

A third embodiment shows a frame rate conversion apparatus which directly uses an input image signal in place of an output from the second scaling circuit 14, as a point different from the first embodiment.

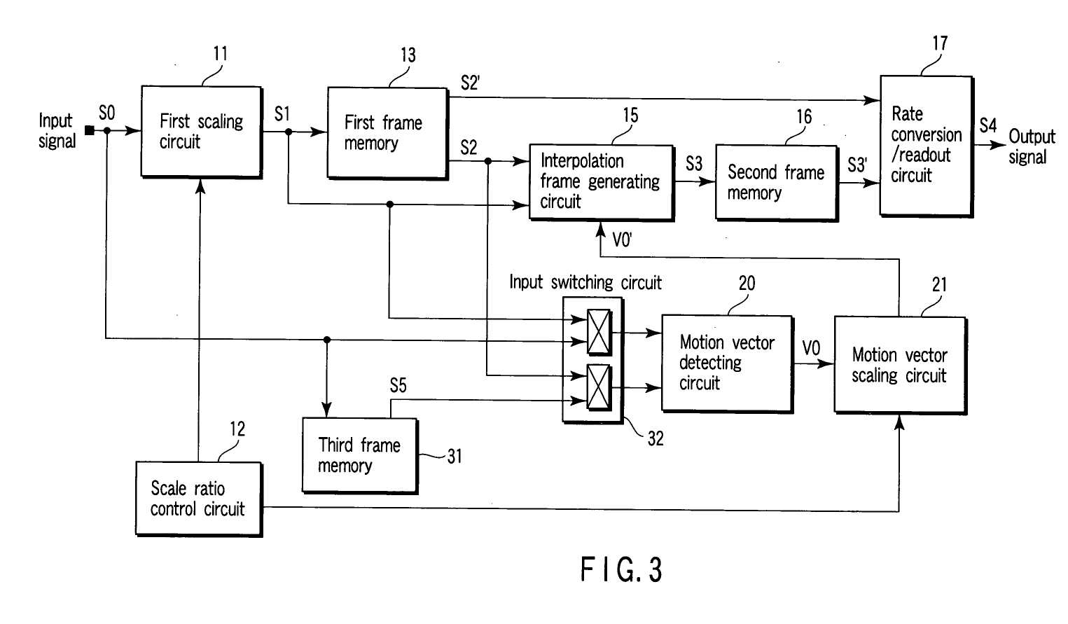

In this case, the delayed action of the third frame memory in the first embodiment is substituted by that an input image signal is restored with respect to unillustrated image corrections such as gamma correction and the like to the original input image signal before being scaled up by the second scaling circuit, and a third scaling circuit is further provided. FIG. 3 is a block diagram showing one example of the first frame rate conversion apparatus according to one embodiment of the present invention.

With respect to the frame rate conversion apparatus shown in FIG. 3, to describe only the structure different from that in FIG. 1, and omit descriptions of the common structures, the third frame memory 31 receiving an input signal is provided, and an output signal S5 therefrom is supplied to the input switching circuit 32. Further, at the input switching circuit 32, an output S1 from the first scaling circuit 11 and an input signal are supplied to the first input terminal thereof. An output S2 from the first frame memory 13 and an output S5 from the third frame memory 31 are supplied to the second input terminal.

The point different from the first embodiment is that an input image signal is directly used in place of an output from the second scaling circuit 14. In this case, it is necessary to carry out unillustrated corrections in image quality such as gamma correction and the like first, and then to input the input image signal to the first scaling circuit 11 and the third frame memory 31. However, it is possible to reduce a circuit scale.

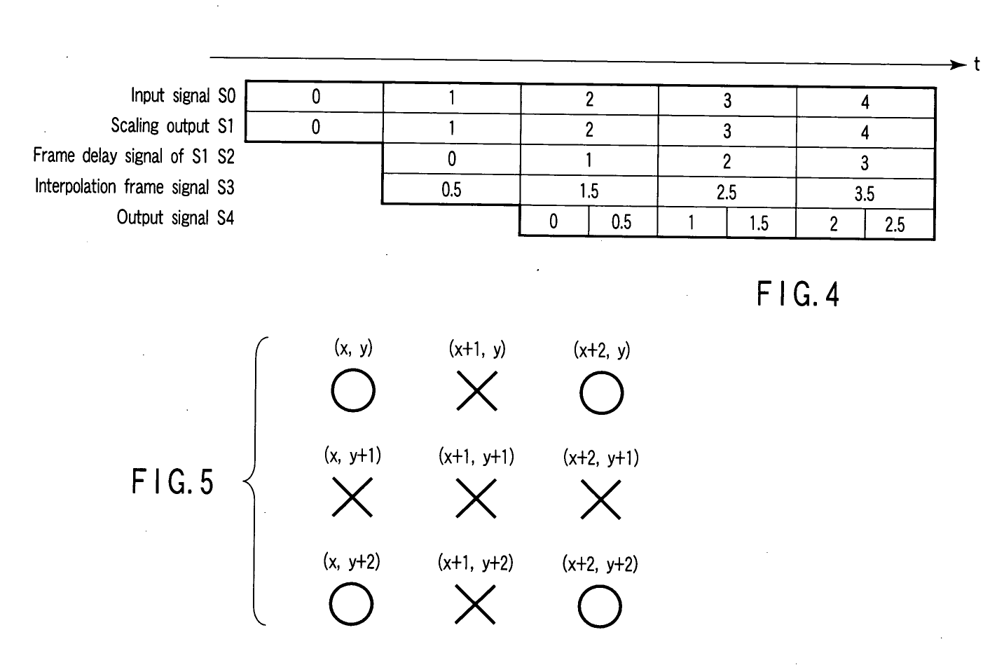

Further, FIG. 4 is an explanatory diagram showing one example of timings of respective signals in the frame rate conversion apparatus according to one embodiment of the present invention. In FIG. 4, frame numbers of output signals corresponding to an input signal SO, a scaling output S1, a frame delay signal S2 of S1, an interpolation frame signal S3, and an output signal S4 are shown.

As described above, in accordance with the frame rate conversion apparatus according to the embodiments of the present invention, a motion vector detection accuracy at the time of scaling up an input image signal to be output at a frame rate being raised is improved, and an attempt can be made to make an output image signal higher quality.

In accordance with the various embodiments described above, those skilled in the art can realize the present invention. Further, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A frame rate conversion apparatus comprising:
a scaling circuit which scales up or scales down an input image signal, and outputs it;
a first frame memory which stores an image signal from the scaling circuit;
supplying means for supplying an input image signal before being scaled up when the scaling circuit has scaled up the input image signal;
a motion vector detecting circuit which receives the input image signal before being scaled up from the supplying means, and which detects a motion vector on the basis of the signal;
a motion vector scaling circuit which carries out scaling onto the motion vector from the motion vector detecting circuit, and outputs it;
an interpolation frame generating circuit which generates and outputs an image signal to be interpolated on the basis of the motion vector from the motion vector scaling circuit, an output signal from the scaling circuit, and an image signal from the first frame memory;
a second frame memory which stores the image signal to be interpolated from the interpolation frame generating circuit; and
a readout circuit unit which receives the image signal from the first frame memory, and the image signal to be interpolated from the second frame memory, and outputs those in accordance with a frame rate.

2. The frame rate conversion apparatus according to claim 1, wherein the supplying means includes
a second scaling circuit which carries out scaling such that the input image signal is restored to an input image signal before being scaled up when the first scaling circuit has scaled up the input image signal, and
a third frame memory which stores the input image signal before being scaled up obtained by the second scaling circuit.

3. The frame rate conversion apparatus according to claim 1, wherein the supplying means includes
a second scaling circuit which receives an output from the first scaling circuit and carries out scaling thereof, and which supplies the output to the motion vector detecting circuit, and
a third scaling circuit which receives an output from the first frame memory and carries out scaling thereof, and which supplies the output to the motion vector detecting circuit.

4. The frame rate conversion apparatus according to claim 1, wherein the supplying means has:
a third frame memory into which the input image signal is inputted; and
an input switching circuit which receives respectively the input image signal and the input image signal which is an output from the third frame memory when the scaling circuit has scaled up the input image signal, and which supplies those to the motion vector detecting circuit.

5. A frame rate conversion method comprising:
scaling up an input image signal, and outputting it;
storing the input image signal which has been scaled up into a first frame memory;
supplying the input image signal before being scaled up;
detecting a motion vector on the basis of the supplied input image signal before being scaled up;
carrying out scaling onto the detected motion vector, and outputting it;
generating an image signal to be interpolated on the basis of the input image signal which has been scaled up and the input image signal outputted from the first frame memory, and outputting it; and
storing the image signal to be interpolated into a second frame memory, and outputting it; and
receiving an image signal from the first frame memory, and the image signal to be interpolated from the second frame memory, and outputting those in accordance with a frame rate.

6. The frame rate conversion method according to claim 5, wherein the method of supplying the input image signal before being scaled up carries out scaling of the input image signal which has been scaled up so as to be restored to an input image signal before being scaled up, and
stores the input image signal before being scaled up into a third frame memory, retrieves it, and supplies it to the detection of a motion vector.

7. The frame rate conversion method according to claim 5, wherein the method of supplying the input image signal before being scaled up generates an input image signal before being scaled up by carrying out scaling of the input image signal which has been scaled up, receives an output from the first frame memory, generates an input image signal before being scaled up by carrying out scaling of the received output, and supplies the respective input image signals before being scaled up to the detection of a motion vector.

8. The frame rate conversion method according to claim 5, wherein the method of supplying the input image signal before being scaled up supplies the input image signal and the input image signal stored in and retrieved from the third frame memory to the detection of a motion vector.
